(19) United States
(12) Patent Application Publication
(10) Pub. No.: US 2010/0275455 A1
(43) Pub. Date: Nov. 4, 2010

(54) Right angle gauge for vise

(75) Inventor: Sen-Kun Chen, Taichung County (TW)

Correspondence Address: Sen-Kun Chen, P.O. Box 44-2049, Taipei, 10668, TW

(73) Assignee: MING SING MACHINES INDUSTRIAL CO., LTD.

(21) Appl. No.: 12/453,074

(22) Filed: Apr. 29, 2009

(51) Int. Cl. G01B 3/56

(52) U.S. Cl. 33/535

(57) ABSTRACT

A right angle gauge for bench vise includes a square block and having a sliding unit is connected to an operation surface of the square block. The sliding unit includes a rail and an engaging member which slidably connected to the rail. A holding unit is connected to the engaging member and a measuring gauge is pivotably connected to the holding unit. The measuring gauge includes a probe connected thereto. The measuring gauge is adjusted along its angle and position easily so that the measurement is conveniently proceeded and the measuring gauge is able to measure the bench vise from different angles.

### BACKGROUND OF THE INVENTION

(1) Field of the Invention

The present invention relates to an angle gauge, and more particularly, to a right angle gauge for measure of bench vise.

(2) Description of the Prior Art

A conventional bench vise is installed on a work bench and object to be machined is positioned by the bench vise. The bench vise has to be installed correctly so as to ensure that the object is machined as expected.

The conventional way to check the bench vise is attach a square block on a side of the bench vise to see the gap between the side of the bench vise and the side of the square block. The users adjust the bench vise to reduce the gap with the square bench. This adjustment has to be taken repeatedly until the bench vise is positioned as desired and this takes a lot of time.

The present invention intends to provide a right angle gauge for bench vise and includes a measuring gauge which is slidably connected to the block of the right angle gauge so as to conveniently measure the bench vises from different angles.

### SUMMARY OF THE INVENTION

The present invention relates to a right angle gauge which comprises a square block, a sliding unit, a holding unit and a measuring gauge. The square block includes an operation surface and the sliding unit is connected to the operation surface. The sliding unit includes a rail and an engaging member slidably connected to the rail. The rail is connected to the operation surface. The holding unit is connected to the engaging member and the measuring gauge is pivotably connected to the holding unit. The measuring gauge includes a probe connected thereto so as to contact the bench vise and provides the measurement information on the measuring gauge.

The primary object of the present invention is to provide a right angle gauge for bench vise and the right angle gauge is able to measure the installation of the bench vise quickly and correctly.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the right angle gauge of the present invention;

FIG. 2 is a perspective view to show the right angle gauge of the present invention;

FIG. 3 is a cross sectional view to show that the display surface of the measuring gauge is oriented upward;

FIG. 4 is a cross sectional view to show that the display surface of the measuring gauge is oriented forward;

FIG. 5 shows that the holding unit and the measuring gauge are movable linearly;

FIG. 6 shows that the right angle gauge measures an end surface of the bench vise, and

FIG. 7 shows that the right angle gauge measures a side surface of the bench vise, the measuring gauge located on top thereof.

### DETAILED DESCRIPTION OF THE PREFERRED EMBODIMENTS

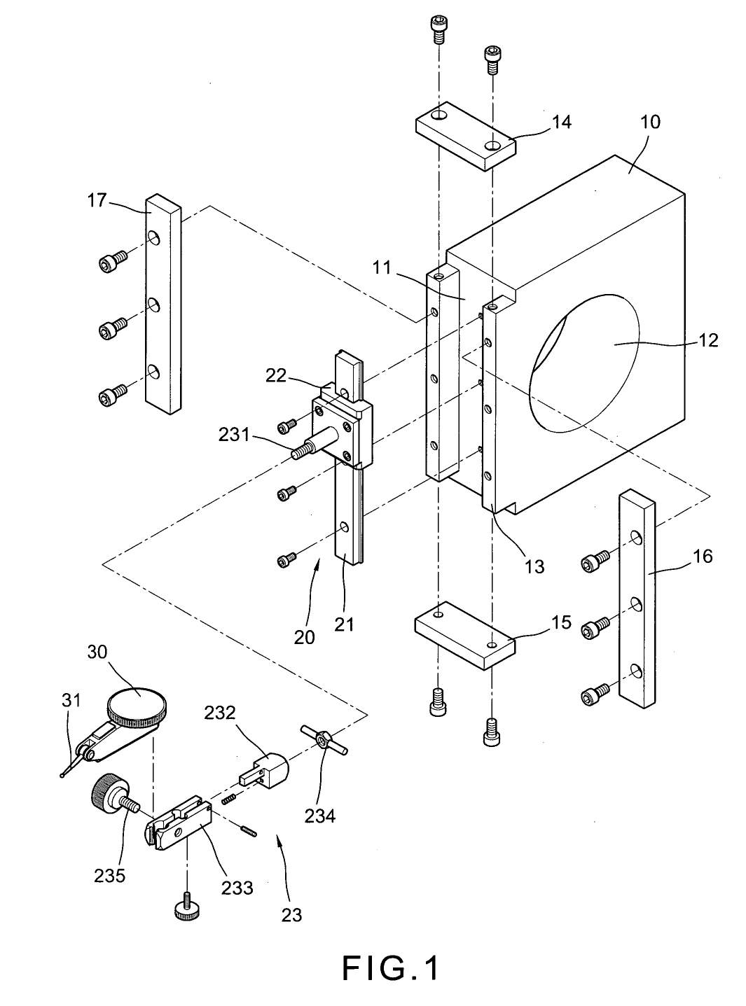

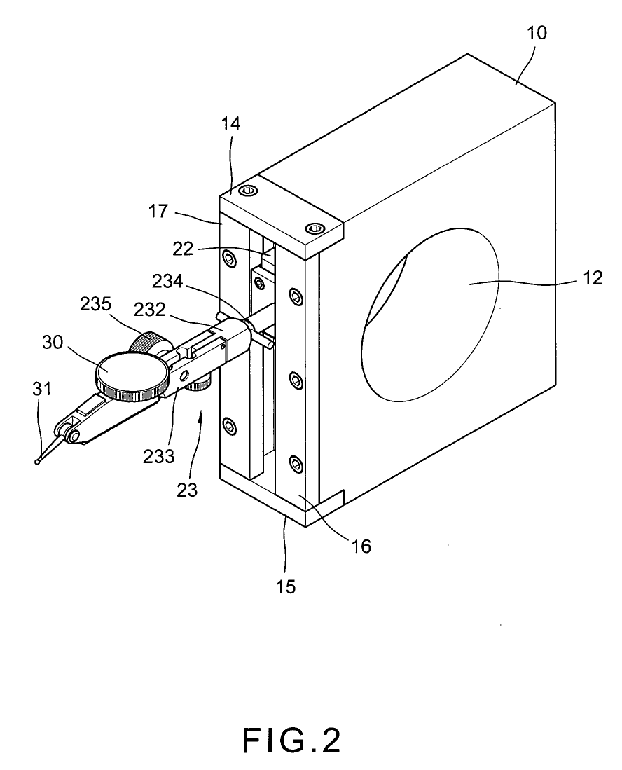

Referring to FIGS. 1 and 2, the right angle gauge of the present invention comprises a comprises a square block 10 having hole 12 defined therethrough so that the user can easily hold the square block 10. The square block 10 includes an operation surface 11 and a sliding unit 20 is connected to the operation surface 11. The sliding unit 20 includes a rail 21 and an engaging member 22 which is slidably and linearly connected to the rail 21. Two flanges 13 extend from the operation surface 11 and the rail 21 is fixed to the operation surface 11 by bolts and located between the two flanges 13. A top board 14 and a bottom bards 15 are connected to two ends of the two flanges 13, two side boards 16, 17 are connected to the two flanges 13 and perpendicularly connected between the top and bottom boards 14, 15 so that the engaging member 22 is movable between the two side boards 16, 17.

A holding unit 23 includes a threaded rod 231 extending from the engaging member 22 and a connection member 232 is connected to the threadedly rod 231 by a nut 234. A clamping member 233 is pivotably connected to the connection member 232 and a measuring gauge 30 is pivotably connected to the clamping member 233. The clamping member 233 includes two side plates between which the measuring gauge 30 is clamped. A bolt 235 extends through the two side plates to control the gap between the two side plates and the measuring gauge 30 is clamped within the gap. The measuring gauge 30 including a probe 31 connected thereto which is connected to the measuring gauge 30 at an angle.

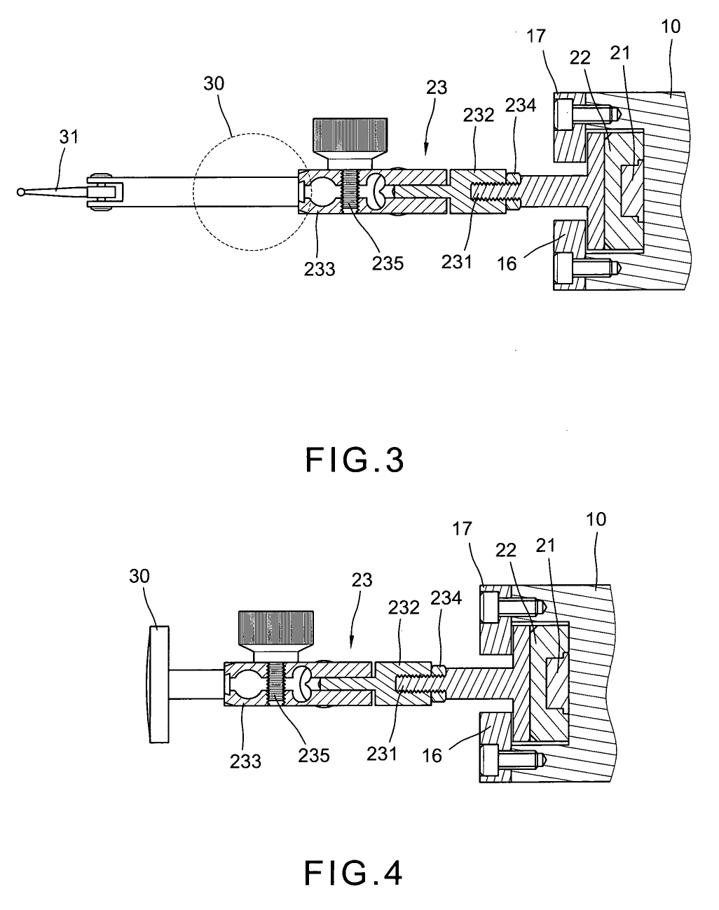

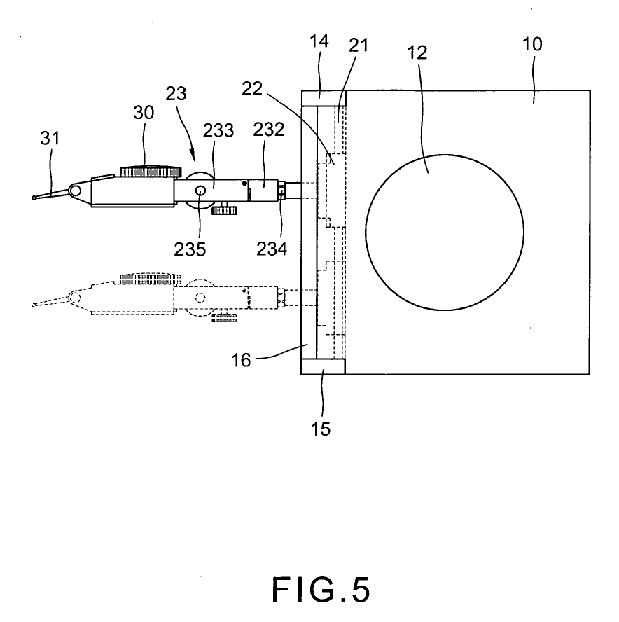

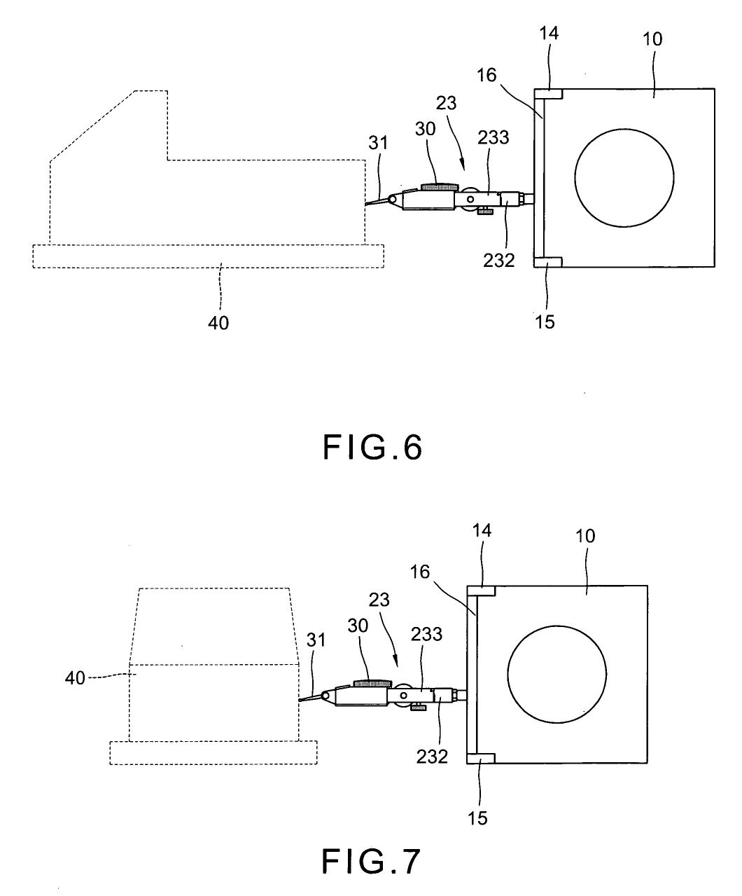

As shown in FIGS. 3 and 4, the measuring gauge 30 is first connected to the clamping member 233 and the display surface of the measuring gauge 30 can be oriented upward or forward for convenience of observation. The holding unit 23 and the measuring gauge 30 are movable linearly along the longitudinal direction of the operation surface 11 as shown in FIG. 5 to allow the probe 31 to measure different positions of the bench vise 40 such as the end surface and side surface as shown in FIGS. 6 and 7.

The users can adjust the connection member 232 and the clamping member 233 to set the measuring gauge 30 at a desired position while the probe 31 is not damaged. The measuring gauge 30 is able to move relative to the square block 10 to measure the bench vise 40 so as to ensure that the bench vise 40 is properly installed.

While we have shown and described the embodiment in accordance with the present invention, it should be clear to those skilled in the art that further embodiments may be made without departing from the scope of the present invention.

What is claimed is:

1. A right angle gauge comprising:
a square block having an operation surface and a sliding unit connected to the operation surface;
the sliding unit having a rail and an engaging member slidably connected to the rail, the rail connected to the operation surface, and
a holding unit connected to the engaging member and a measuring gauge pivotably connected to the holding unit, the measuring gauge including a probe connected thereto.

2. The gauge as claimed in claim 1, wherein two flanges extend from the operation surface and the rail is located between the two flanges, the engaging member is linearly and slidably connected to the rail, a top board and a bottom bards are connected to two ends of the two flanges, two side boards are connected to the two flanges and perpendicularly connected between the top and bottom boards so that the engaging member is movable between the two side boards.

3. The gauge as claimed in claim 1, wherein the square block includes a hole defined therethrough.

4. The gauge as claimed in claim 1, wherein the holding unit includes a threaded rod extending from the engaging member and a connection member is connected to the threadedly rod by a nut, a clamping member is pivotably connected to the connection member and the measuring gauge is pivotably connected to the clamping member.

5. The gauge as claimed in claim 4, wherein the clamping member includes two side plates between which the measuring gauge is clamped, a bolt extends through the two side plates to control a gap between the two side plates.
